(19) United States
(12) Patent Application Publication
(10) Pub. No.: US 2018/0210078 A1
(43) Pub. Date: Jul. 26, 2018

(54) METHOD FOR COLOURING SAR IMAGES, AND RADAR CAPABLE OF IMPLEMENTING SUCH A METHOD

(71) Applicant: THALES, COURBEVOIE (FR)

(72) Inventors: Patrick GARREC, MERIGNAC (FR); Vincent CORRETJA, PESSAC (FR); Julien PETITJEAN, PESSAC (FR); Richard MONTIGNY, PESSAC (FR)

(73) Assignee: THALES, COURBEVOIE (FR)

(21) Appl. No.: 15/576,246

(22) PCT Filed: Jun. 8, 2016
(86) PCT No.: PCT/EP2016/063026

§ 371 Date: Nov. 21, 2017

(30) Foreign Application Priority Data
Jun. 17, 2015 (FR) 1501260

(51) Int. Cl. G01S 13/90; G01S 7/06; G01S 13/86

(52) U.S. Cl. CPC G01S 13/9029; G01S 2013/9076; G01S 13/867; G01S 7/062

(57) ABSTRACT

A method comprises at least the following steps: a step of acquiring data by radar to obtain an SAR image covering a given geographical domain; a step of acquiring at least one secondary image covering the domain, produced by a source external to the radar, the image supplying information on the colors of the constituent elements of the SAR image; a step of superimposing the SAR image and the secondary image; a step of assigning colors to the elements on the basis of their position in the superimposed secondary image.

The present invention relates to a method for colouring SAR images. It also relates to a radar capable of implementing such a method. The invention is applicable, for example, to multifunction airborne radars producing SAR images.

The images produced by synthetic aperture radars, also called SAR images in English terminology, may be used, notably, to obtain views at all times, in daytime and at night, and can even penetrate some surfaces or some environments such as vegetation, making these surfaces or environments transparent. They therefore have an advantage over optical images. A drawback of these SAR images is their lack of realistic colouring. They allow shapes and shadows to be distinguished, but with arbitrary colors. Consequently, their use or analysis is not a simple matter, and the interpretation of the elements of these images requires training or learning.

There are known colouring solutions, but the colors assigned to the components of the SAR image are arbitrary, the image being in false colors. In these solutions, the HH channels are red, for example, the HV channels are green and the VV channels are blue, where H corresponds to horizontal polarization and V corresponds to vertical polarization. These colors are not intended to be realistic, but are simply used to facilitate technical analysis by an expert. These colors are not intended in any way to facilitate interpretation by a simple, non-expert operator.

Therefore, existing SAR images require a considerable amount of operator training for their interpretation and analysis.

Indeed, the interpretation of a SAR image is very different from the interpretation of an image acquired by an optical sensor. This is because they are uncolored. They provide information relating to the roughness of the sensed surface. An operator used to viewing conventional video is disconcerted when he encounters the representation provided by a SAR image.

One object of the invention is to overcome this drawback by providing, notably, usable colouring of a SAR image, that is to say colouring that can be understood by any operator. For this purpose, the invention proposes a method for colouring SAR images produced by a radar, said method being implemented by said radar, and comprising at least the following steps:

a step of acquiring data by means of said radar to obtain said SAR image covering a given geographical domain;

a step of acquiring at least one secondary image covering said domain, produced by a source external to the radar, said image supplying information on the colors of the constituent elements of said SAR image;

a step of superimposing said SAR image and said secondary image;

a step of assigning colors to said elements on the basis of their position in said superimposed secondary image.

In a possible embodiment, said external source is a file of prerecorded images, the prerecorded images being supplied by a search engine, for example.

Said external source is, for example, a digital terrain model, said secondary image being a representation of said domain in said model.

Said external source may also be, for example, an optical sensor on board the carrier of said radar.

In the presence of at least one moving target, the latter is, for example, assigned a color relating to the color of said target produced by said optical sensor.

In a particular embodiment, at least one element is assigned an arbitrary color.

The invention also proposes a radar implementing the method as described above.

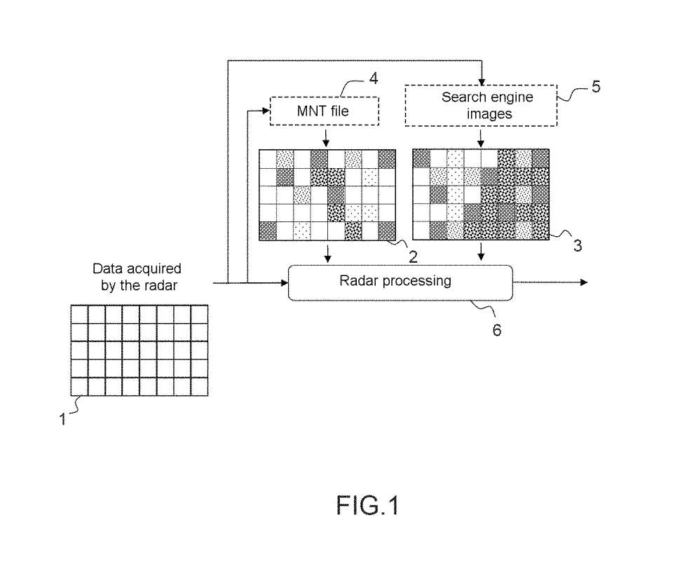

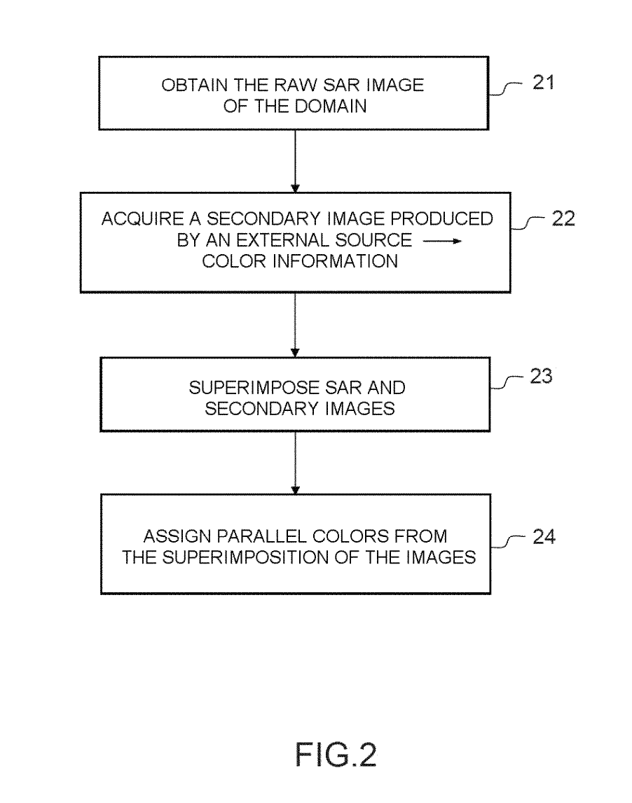

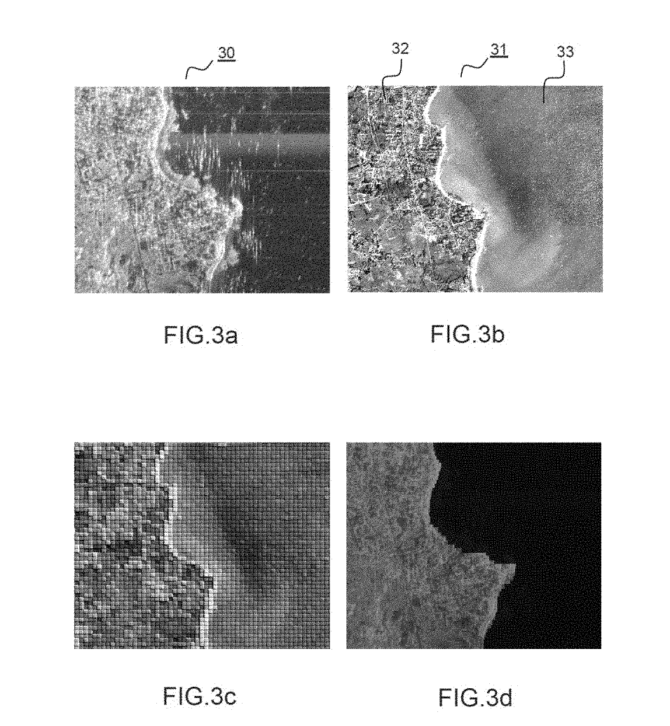

Other characteristics and advantages of the invention will be apparent from the following description, provided in the light of the attached drawings, which show:
in FIG. 1, an illustration of the principle of the invention;
in FIG. 2, a presentation of possible steps for the implementation of the method according to the invention;
in FIGS. 3a to 3d, an example of the application of the method according to the invention.

FIG. 1 illustrates the principle of the method according to the invention. Advantageously, in order to produce the images, the invention makes use of secondary images 2, 3 originating from source other than the radar capture, and couples these images to the data 1 acquired by the radar, the colors being obtained by means of these data 2, 3.

To obtain a conventional uncolored SAR image, referred to below as the basic SAR image or raw image, the method uses the conventional means of obtaining SAR images, which are well known.

In the example of implementation illustrated in FIG. 1, the method uses two external image sources:

data 2 obtained from a digital terrain model, denoted MNT, providing a particular representation of the domains covered by the SAR images; and

images 3 supplied by a search engine 5, which may also be referred to below as external images.

These representations are, for example, known a priori. The MNT data sources or the search engine are, to certain degree, entities which supply a priori knowledge of the places imaged by the radar, this a priori knowledge being intended to be coupled to the SAR images produced in real time.

The MNT data are, for example, stored in a file 4, the other data 3 being accessible via the search engine 5, that is to say both in real time and via storage by the radar processing means.

The radar processing means 6 use the data 1 acquired by the radar, the MNT data and the data obtained from the search engine. The radar data may be used to obtain the basic SAR image in a known way. The MNT data may be used, notably, to obtain a representation based on the altitude of the constituent elements of the SAR image. The images supplied by the search engine may be used, notably, to obtain the texture of these elements.

The data acquired by the radar are used to locate the scene or geographical domain that is imaged. In particular, the geographic coordinates of the SAR image are obtained by the georeferencing system of the platform carrying the radar.

On the basis of this geographic location of the domain, it is therefore possible to acquire the secondary images covering this domain in the MNT model and from the search engine. The supplying entities then deliver texture characteristics, for the search engine, and altitude characteristics for the MNT file 4, all of this information enabling colors to be assigned to the various constituent elements of the SAR image.

The secondary images, formed from the MNT representations and the external images obtained from the search engine, are input data for the radar processing 6. The colouring of a SAR image is obtained by superimposition of this image with the MNT representations and the external image. The MNT data is accessed via a suitable interface between the file 4 and the processing means 6. The search engine data are accessed either via suitable internet communication or via a suitable interface with a file which stores these data or equivalent data.

The principle of the invention having been illustrated in FIG. 1, FIG. 2 shows the various possible steps of the method according to the invention.

Thus FIG. 2 illustrates the possible steps for colouring a SAR image covering a given geographical domain. This is applicable in the same way to all SAR images.

In a first step 21, the radar acquires the data to obtain the basic SAR image, covering the geographical domain.

This first step 21 is followed by a step of acquiring at least one secondary image supplied by a source external to the radar. The expression “source external to the radar” is taken to mean a source that supplies image data not making use of radar detection. This secondary image provides color information for the constituent elements of the basic SAR image. As mentioned above, this information may be texture information if the external source is a search engine, or altitude information if the external source is a digital terrain model MNT. As in the example of FIG. 1, it is possible to provide two or more external sources. Another external source may be, for example, an optical sensor on board the carrier of the radar, the data received by the sensor then being transferred to the radar processing means.

In a following step 23, the processing means carry out the superimposition of the basic SAR image with the secondary image produced by the external source. If a plurality of external sources are used, the superimposition relates to all the secondary images with the SAR image. In this case, each secondary image may be superimposed with the SAR image. Thus, if there are two secondary images, two superimpositions are performed.

The superimposition consists in comparing the digital data forming an image of the domain. Methods of superimposition are described below.

In the next step 24, the colors are assigned to the various elements of the SAR image on the basis of the result of the superimposition of the images. For example, if the MNT representation indicates that an area of the image corresponds to a water surface, notably the sea, the area may be colored blue. The image supplied by the search engine provides, for example, more detailed information on the texture of the elements. The colors finally assigned may or may not be arbitrary, and are, notably, intended to make the SAR image more comprehensible. Arbitrary colors may be different from the real colors produced by the secondary images.

A number of solutions may be used to superimpose the secondary image or images with the SAR image. In order to superimpose all these representations, namely the SAR image, the MNT image and the external image, they must be geographically adjusted and all brought to the same scale.

In a first solution, the various images may be referenced relative to a unique point present in the SAR image and in the secondary images. The radar processing means may use GPS information to reference the various images relative to this unique point. In particular, the GPS coordinates of the unique point are used, these coordinates being the reference coordinates for all the superimposed images.

The SAR images are, for example, adjusted relative to the secondary, MNT and other images, by correlation in the image. As mentioned above, the geographic coordinates of an SAR image are, for example, obtained by the georeferencing system of the carrier.

The secondary images, namely the MNT and other images, are divided into areas by means of these geographic coordinates to perform the superimposition of the images, the corresponding areas between images being superimposed.

Adjustment is performed by adapting the sizes of the secondary images by stretching the data of the secondary images corresponding to the georeferencing of the data of the SAR image, the stretching corresponding to a change of scale. The data of the images are, notably, the pixels, or the altitude data for the MNT representation. The stretching adjusts the positions of the pixels or the points of altitude measurement in the image.

When this division has been performed, it may be necessary to carry out a fine superimposition of the two images. This superimposition is performed, for example, on distinctive points. Since the images are digital, the superimposition may also be performed by a digital correlation of the two images, namely the SAR image and the secondary image, enabling the displacements between the two images to be measured. For this purpose, a video-type secondary image, obtained notably from a search engine or an optical sensor, may, for example, be transformed into gray levels for greater convenience, with subsequent stretching. A first-order Laplace operator is also used to determine the contours of the objects or elements of the images by known techniques, relative to an average threshold.

When the dimensions have been adjusted, and the superimposition is therefore completed in the corresponding step 23, the colors may be assigned to the elements of the SAR image in the next step 24 by point-to-point correlation, by making the color information (red, green and blue of the digital coding) retrieved from the secondary image correspond. The intensity is applied, for example, by directly using the information obtained from the SAR image.

Conventional contour processing is performed, for example, to prevent the colors from spreading over the contours.

A color intensity gradient is, for example, used by labeling the areas of the SAR image by uniqueness of color, the color being uniform over the whole of an area.

As a general rule at least, the color of a moving target present in a SAR image is not known a priori. This is because this target is not present in the secondary images that are prerecorded, particularly in the case of images obtained from search engines or MNT models.

For processing when moving targets are present, these targets are dynamically adjusted on the SAR image and an arbitrary color may be assigned to them; this color must be different from the background to aid their display.

If the secondary image is produced by an optical sensor in real time, moving targets may be labeled with colors relating to the colors of the real target.

In a variant form of colouring, in order to optimize the color, the colors obtained from the search engine file, for example, are used, and their intensity is adjusted proportionally to the intensity of the signal backscattered in the SAR image.

All these processes for colouring SAR images with the aid of external image sources may be performed by the radar processing means 6 without any special arrangements. It may simply be necessary to provide a number of additional communications interfaces.

FIGS. 3a to 3d show, by way of example, the colouring of a SAR image according to the invention, with the aid of files of secondary images, more particularly with the aid of a MNT file or with the aid of a prerecorded image supplied by a search engine.

FIG. 3a shows the basic SAR image 30 at the output of the radar processing. The optical image of the imaged area is given in FIG. 3b. FIG. 3 shows the image supplied by the search engine. The MNT file corresponding to the imaged area 31 is also available. By distinguishing the land 32 from the sea 33, using the MNT file, the colored image shown in FIG. 3d is produced. In this example of colouring, the sea is represented in blue and the land is represented in red.

The invention advantageously makes it possible to simplify and share the training of the operators, who will thus be able to concentrate more closely on their task, since less effort is required to interpret the images.

1. A method for colouring SAR images produced by a radar, wherein, said method being implemented by the means for processing said radar, comprises at least the following steps:
a step of acquiring data by means of said radar to obtain said SAR image covering a given geographical domain;
a step of acquiring at least one secondary image covering said domain, produced by a source external to the radar, said image supplying information on the colors of the constituent elements of said SAR image;
a step of superimposing said SAR image and said secondary image;
a step of assigning colors to said elements on the basis of their position in said superimposed secondary image.

2. The method as claimed in claim 1, wherein said external source is a file of prerecorded images.

3. The method as claimed in claim 2, wherein the prerecorded images are supplied by a search engine.

4. The method as claimed in claim 1, wherein said external source is a digital terrain model, said secondary image being a representation of said domain in said model.

5. The method as claimed in claim 1, wherein said external source is an optical sensor on board the carrier of said radar.

6. The method as claimed in claim 5, wherein, in the presence of at least one moving target, the latter is assigned a color relating to the color of said target produced by said optical sensor.

7. The method as claimed in claim 1, wherein at least one element is assigned an arbitrary color.

8. A radar capable of executing the method as claimed in claim 1.
